(19) United States
(12) Patent Application Publication
(10) Pub. No.: US 2012/0314438 A1
(43) Pub. Date: Dec. 13, 2012

(54) Handle Member For A Motor Vehicle

(75) Inventors: Stephan GUTT, Munchen (DE); Carter Scott CANNON, Munchen (DE)

(73) Assignee: INTERNATIONAL AUTOMOTIVE COMPONENTS GROUP GMBH, Krefeld (DE)

(21) Appl. No.: 13/436,345

(22) Filed: Mar. 30, 2012

(30) Foreign Application Priority Data
Apr. 1, 2011 (DE) 10 2011 001 737.2

(51) Int. Cl. B60Q 1/26; F21V 11/00; F21V 8/00; F21V 5/04; F21V 17/12; F21V 17/16

(52) U.S. Cl. 362/511; 362/549; 362/545

(57) ABSTRACT

Handle member for a motor vehicle having a body and at least one decorative attachment piece, with a light source being integrated in said attachment piece.

The present invention relates to a handle member for a motor vehicle in accordance with the preamble of claim 1. The invention is in particular applicable to handle members that are mounted to the interior trim of a motor vehicle, for example, on a handhold, a pull handle, a rail or the like, or over a vehicle door, on the roof liner, on a motor vehicle console such as a center console, on a liftgate or on a loading bed. The invention is also applicable to grab bars, a railing or another handle member on the exterior of the vehicle.

An interior trim for the door of a motor vehicle is known from GB 249617 A having a door handle and an illuminating device. A gap is provided between individual trim panels through which the light from the illuminating device can escape in order to illuminate the interior trim in the area of the door handle, and thus to indicate whether the door is opened. The arrangement of an illuminating device in the gaps of the interior trim panels requires specialized adaptation of the interior trim to the illumination and an intricate fitting of the illuminating device behind the interior trim.

An illuminating device for a motor vehicle which employs LEDs is known from DE 198 05 771 A1, which device is configured as part of an interior rear-view mirror, a decorative strip, a door handle or an exterior rear-view mirror. The illuminating device may be in the form of a cover ring or cover cap of an exterior rear-view mirror. This document does not deal with the illumination of a handle member or its surroundings.

Additional documents relating to the illumination of the interior or exterior spaces of motor vehicles are DE 10 2009 022 806 A1, DE 10 2007 033 218 A1; DE 10 2004 001 466 A1; DE 102 11 123 A1; DE 100 46 840 A1; DE 198 09 716 A1; DE 603 19 691 T2; DE 10 2006 019 284 A1; DE 10 2006 024 194 A1; DE 10 2007 013 925 A1; DE 10 2008 023 407 A1; DE 10 2009 005 558 A1; and DE 20 2005 003 591 U1.

An object of the present invention is to provide lighting for a handle member or for the area surrounding the handle member of a motor vehicle which can be easily integrated into the existing design of the motor vehicle trim.

This objective is achieved by a handle member according to claim 1. Preferred embodiments are specified in the dependent claims.

The invention provides a handle member of a motor vehicle, having a body and at least one decorative attachment piece, into which attachment piece a light source is integrated. The light source, which serves to illuminate the handle member and its surroundings, can, according to the present invention, be easily integrated into the existing design of the interior trim. The attachment piece is a part that is mountable on the body of the handle member, thus making it unnecessary to pass the lighting device and associated current supply and control leads through the interior of the body. The invention requires, therefore, no adaptation of the handle member design and/or the interior trim and no penetration into the lamination or other surface design optionally applied to the handle member or interior trim. Rather, housing the light source in the decorative attachment piece makes it possible to produce the handle member and the interior trim that supports it without modifying them in any way, wherein the attachment piece accommodating the light source is easily mounted on the body of the handle member. This solution allows handle members with and without illumination to be produced for like vehicle models as well as identical attachment pieces to be produced for different handle designs.

Especially in the case of high-end vehicle models, in which the interior trim and handle member are laminated with leather or some other material, the present invention solves in a simple manner problems that arise in the prior art because, in order to create illumination, an opening must be made through the interior trim support and/or the body of the handle member, and therefore, also through the lamination applied thereon. It is understood that the invention is not limited to a laminated interior trim.

In the preferred embodiment according to the invention the attachment piece is a ring or partial ring that is mounted on the body of the handle member, or is an insert attached to the latter.

The attachment piece can be form- and/or force fitted in the body. It can be self-positioning by virtue of its shape. Preferably, the attachment piece is detachably affixed to the body, for example, by means of a click-on or snap connection. It is also feasible to affix the attachment piece using additional means, such as pins or clamps. Thus, the attachment piece and light source associated therewith can be precisely positioned and affixed on the handle member in a simple manner, without having to particularly adapt the body of the handle member for purposes of illuminating, or without the need for specialized tools.

In the preferred embodiment of the present invention the light source comprises one or more LEDs, for example, a single LED, two or three LEDs. The invention is not limited to the use of LEDs. In one embodiment, the light source is part of a lighting module which further comprises a circuit board supporting the light source and a circuit for controlling the light source on said circuit board. The circuit board is preferably a flexible circuit board, for example, a FPC- or FR4-substrate, which carries the current supply and/or control leads for the light source. Rigid circuit boards may also be used, and the light source may be mounted with no circuit board at all. It is especially preferred if a lighting module is constructed with a flexible circuit board and one or more LEDs in addition to an electrical plug connector. Furthermore, a housing for the LEDs can be integrated in the lighting module which comprises a light shaping cover, for example, made of a PMMA material or some other transparent material for directing and optimizing the emission of light.

The light source is preferably securely affixed to the attachment piece, for example, adhered, welded, or molded to, or locked in place or imbedded in the attachment piece.

It is preferable if the attachment piece includes an opening, for example, a slotted hole, out of which the light emitted from the light source exits. A light shaping cover may be arranged in this opening, for example, a lens arrangement or a diffusor or some other light shaping covering, such as the aforementioned transparent materials. It is also possible to make the attachment piece completely out of a transparent or semi-transparent material. The material itself can form the light source, for example, when using electroluminescent illumination. The direction of emission of the light source is in principle unlimited, an all-around light falls equally within the scope of the invention as a directed light emission.

In the preferred embodiment of the present invention the current supply and/or control feeds of the light source, preferably via flexible printed circuit boards, are guided along the exterior of the body to the light source. Hence, it is not necessary to provide an opening in the body for guiding the current supply and/or control feeds.

The present invention is described in greater detail below by way of exemplary embodiments and with reference to the drawings. In the Figures:

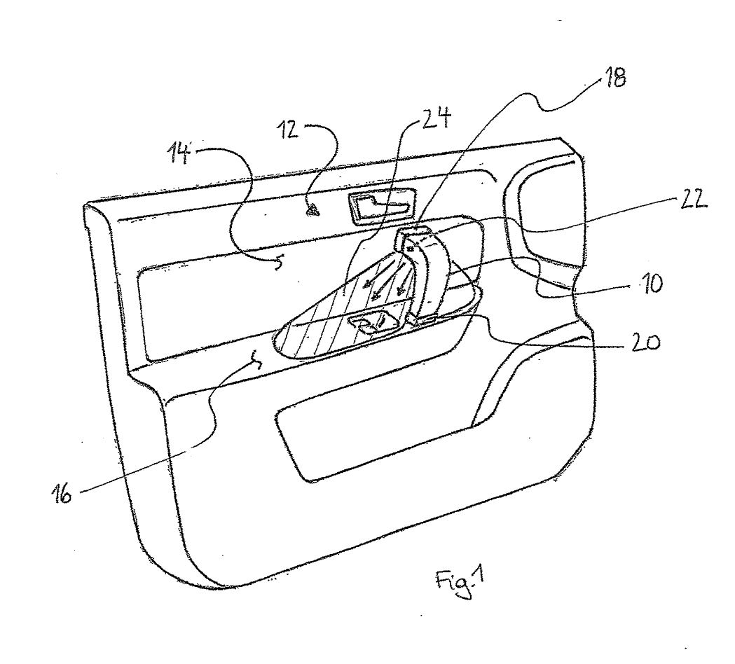

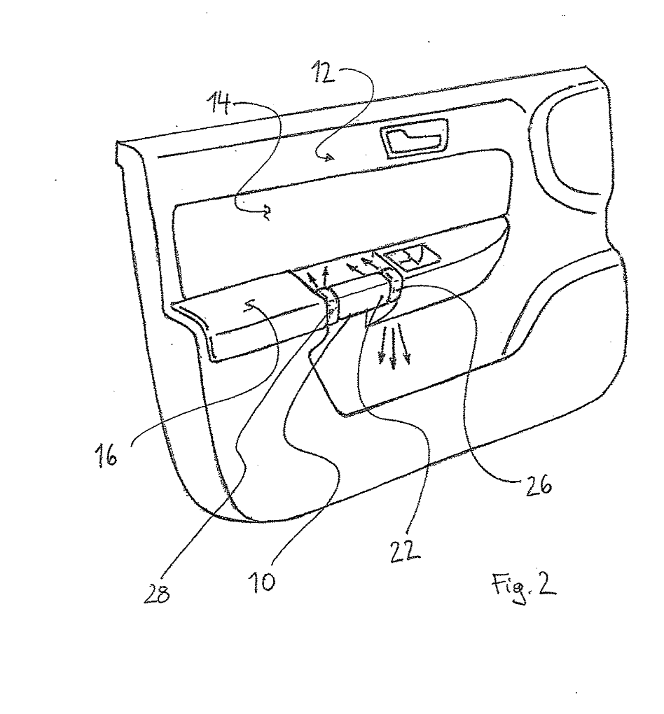

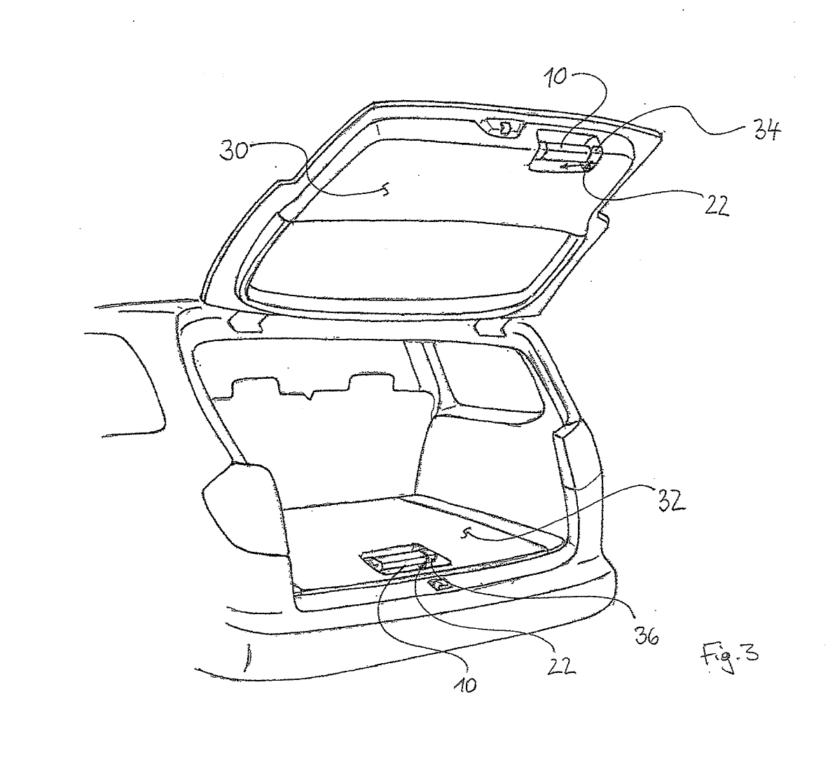

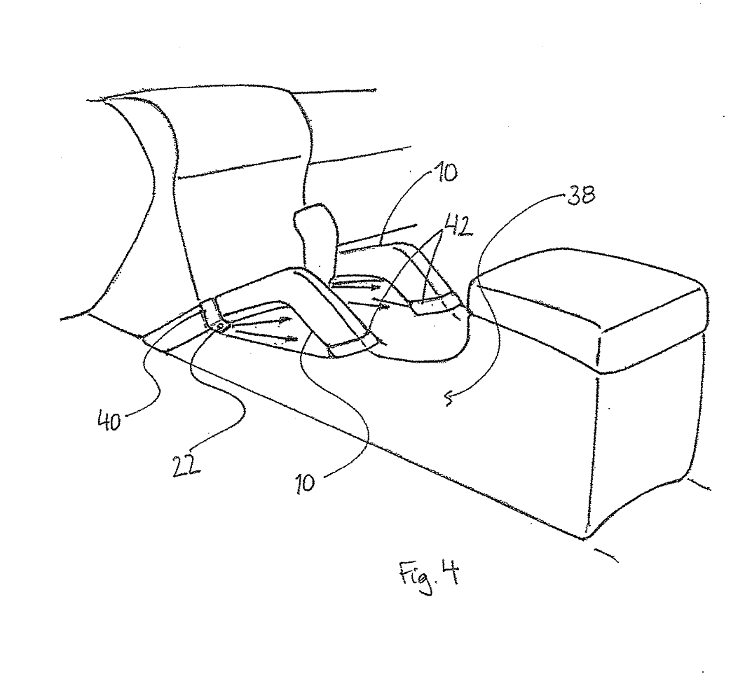

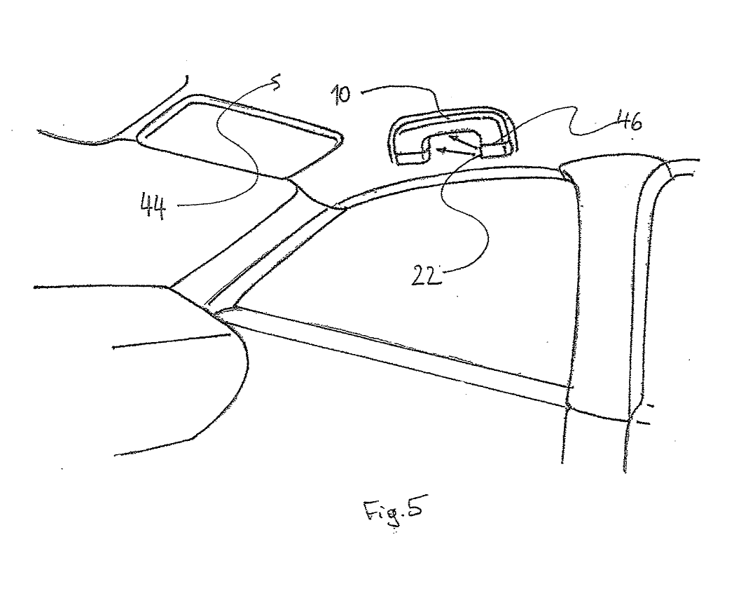

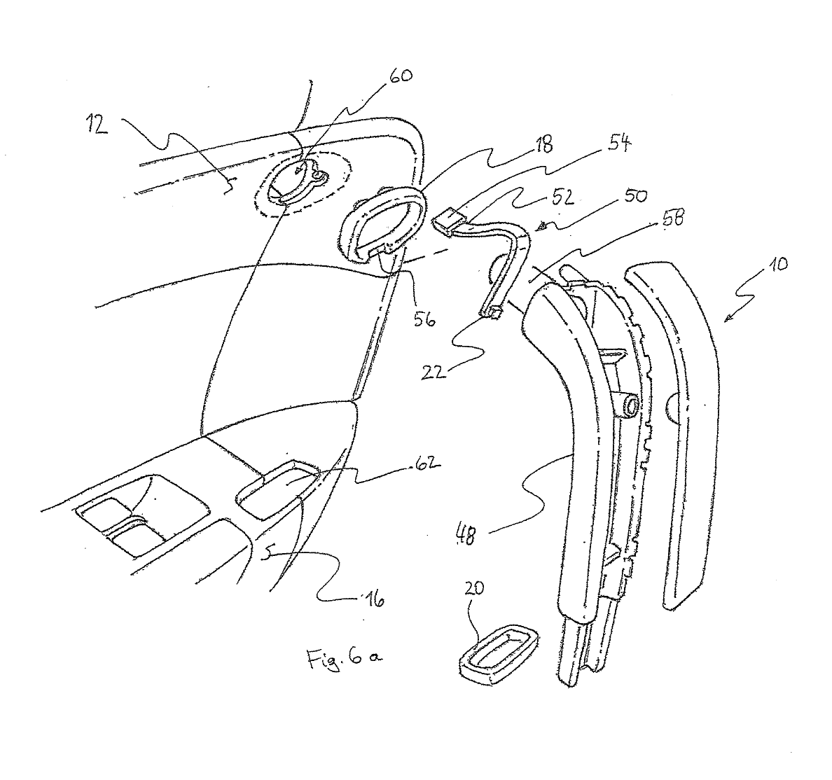

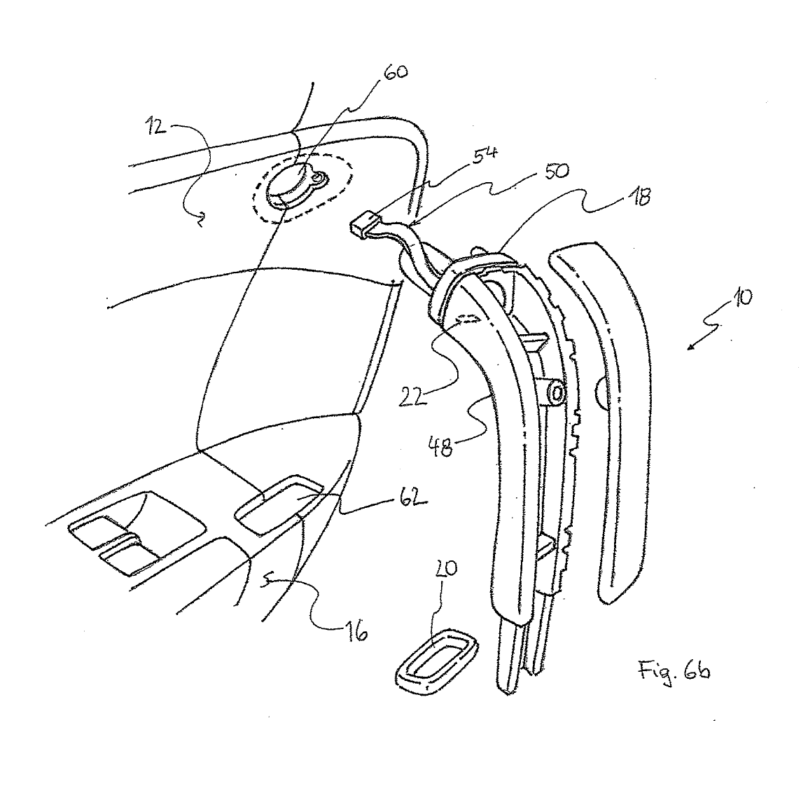

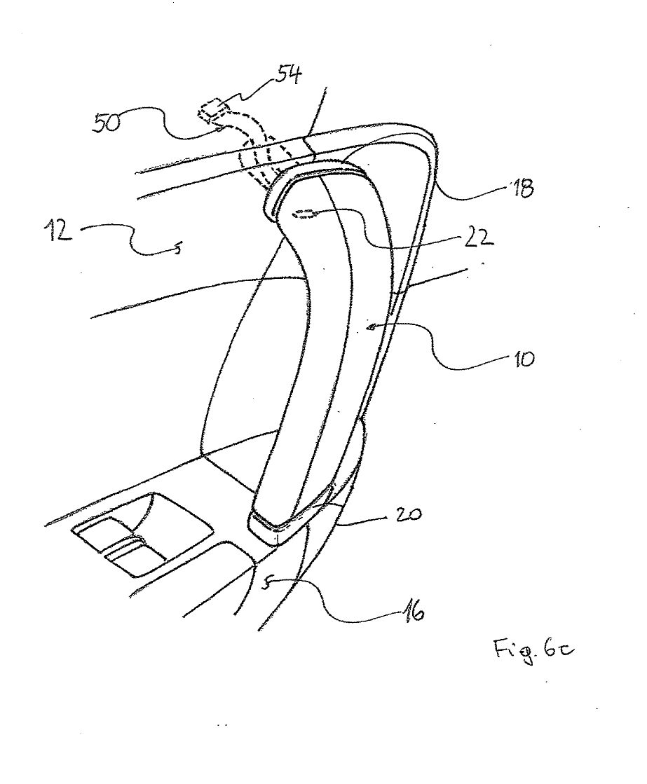

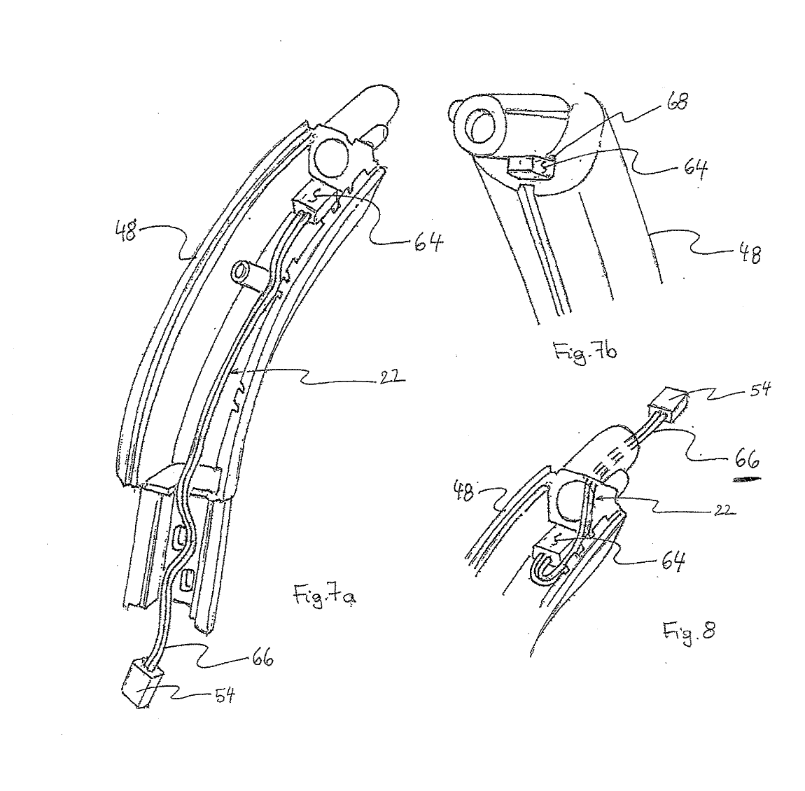

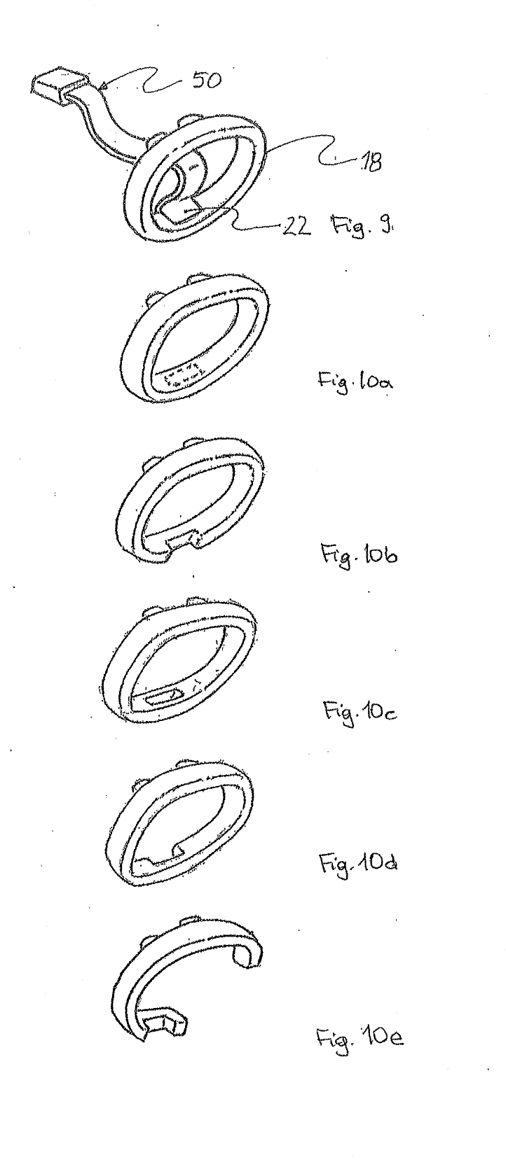

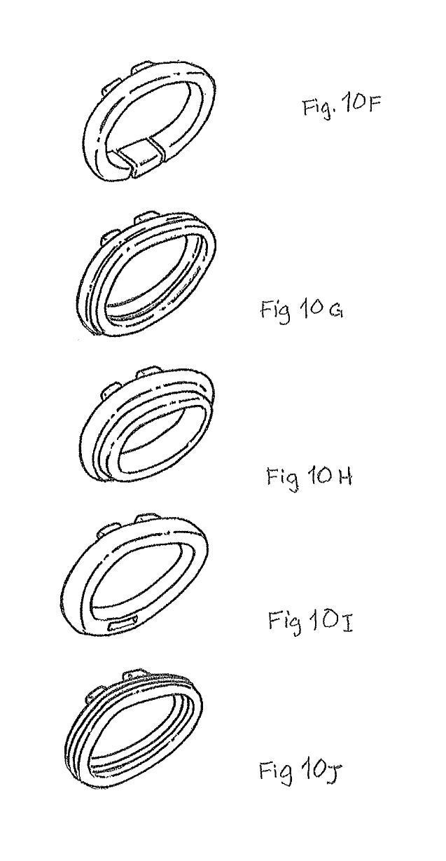

FIG. 1 is an isometric view of an interior door trim of a motor vehicle having a handle member according to the invention;

FIG. 2 is an isometric view of a modified interior door trim of a motor vehicle having a handle member according to the invention;

FIG. 3 is an isometric view of the liftgate and cargo space of a motor vehicle having handle members according to the invention;

FIG. 4 is an isometric view of a center console of a motor vehicle having handle members according to the invention;

FIG. 5 is an isometric view of a portion of the interior space of a motor vehicle having a handle member according to the invention;

FIG. 6a is an exploded view of the handle member of FIG. 1;

FIGS. 6b and 6c are further views of the handle members of FIG. 1 in a partially or fully mounted state;

FIGS. 7a and 7b are isometric views of a modified embodiment of the handle member of FIGS. 6a to 6c;

FIG. 8 is a partial view of another modified embodiment of the handle member of FIGS. 6a to 6c;

FIG. 9 is an isometric view of an attachment piece with lighting module for a handle member according to the invention; and

FIGS. 10a to 10j are isometric views of various embodiments of attachment pieces for use with a handle member according to the invention.

FIG. 1 shows an embodiment of a handle member 10 according to the present invention in the form of a pull handle, which is attached to the interior trim 12 of a motor vehicle door. In the embodiment shown the interior trim comprises an insert 14 and an arm rest 16, each of which are formed from molded parts in a manner known in the art. Also integrated in the interior door trim 12 are additional components known per se, such as a door side pocket, control switch for a window lifter, door opener lever, etc., which do not constitute subject matter of the present invention and need not be described in any further detail herein.

The handle member 10 is attached to the interior trim 12 in a manner known in the art. In the embodiment shown, both ends of the handle member 10, that is, where it is connected to the interior trim 12, are finished off by decorative rings 18, 20. Instead of rings, partial rings or other decorative elements may also be provided. One or more of such attachment pieces can be arranged at various positions on the handle member. On the one hand, the rings 18, 20 form decorative elements which lend the motor vehicle a high-end appearance; on the other hand, they also serve as a trim for the edges of a lamination optionally applied to the handle member 10, for example, of leather, and they provide a technical and visual finish to the handle member. The rings 18, 20 are examples of an attachment piece according to the present invention for accommodating a light source, represented schematically at 22 in FIG. 1. The light source 22 is integrated in the ring 18—that is, in an attachment piece of the handle member 10—in order to illuminate part of the area around the handle member 10 or the handle member itself. The attachment piece itself may also form the light source. The area 24 in the embodiment of FIG. 1 illuminated by light source 22 is indicated by cross-hatching. As is discussed further below, the light source 22 is part of a lighting module.

FIG. 2 shows an alternative arrangement of the handle member according to the present invention on an interior door trim 12 of a motor vehicle. Like components are designated with the same reference numerals as in FIG. 1. In the embodiment of FIG. 2 the handle member 10 is arranged substantially horizontally in the area of an arm rest 16 and is finished off by two rings 26, 28. Instead of a rigid handle bar, provision can be made in this and the other exemplary embodiments for a flexible loop. It is understood that the rings or the attachment piece are not necessarily arranged at the ends of the handle member, but in any desired location. Just as in the preceding and in the following exemplary embodiments, the rings form decorative attachment pieces for accommodating the light source of a lighting module (not shown in FIG. 2). In FIG. 2 the direction of emission of the light source is indicated by arrows. Any other direction of illumination as well as all-around illumination and illumination of the handle member itself fall within the scope of the present invention. Options for accommodating and arranging the lighting module and light source are described below with reference to FIG. 6. ff, the options for accommodating and arranging described being applicable for all exemplary embodiments. The same applies to the accommodation and guiding of control and current supply feeds for the light source.

FIG. 3 shows another exemplary embodiment in which the handle member 10 according to the invention is attached to the interior trim 30 of a liftgate and to the loading bed 32 of the cargo space of a motor vehicle. In this embodiment as well, the handle members 10 are finished off by rings 34, 36, to which extent the same applies as described above. Integrated into each of the rings 34, 36 is a light source, designated by 22 but not shown in detail in FIG. 3.

FIG. 4 shows another example of the handle members 10 according to the invention, arranged on the center console 38 of a motor vehicle. In this example as well, the handle members 10 are finished off by rings 40, 42, wherein in one of the rings 40, respectively, the light source 22 is integrated in accordance with the present invention, again not shown in detail in the Figure.

FIG. 5 shows still a further example of the handle member according to the invention, arranged on the roof liner 44 of a motor vehicle. The ends of the handle member 10 in this exemplary embodiment also include two rings 46, a light source 22 being integrated into at least one of the rings. As in the foregoing embodiments, the direction of emission of the light source is indicated by arrows. The handle member 10 shown in FIG. 5 can fold out.

As demonstrated above, the present invention is applicable to handle members of a motor vehicle; it is not intended to be used for illuminating other parts of the vehicle, in particular door locks and opener levers on car doors.

The light source can be regulated to have both an illuminating and a display function by, for example, blinking to signal a warning. It is conceivable, for example, in a pull handle on a vehicle door to indicate by blinking whether the door should be opened or closed because of an obstruction in the vicinity of the door.

In the exemplary embodiments shown of the handle member according to the invention, the attachment piece for accommodating the light source is designed in the shape of a ring with the handle member arranged at one end thereof and, aside from its decorative function, it can also serve as a trim for the edges of a lamination optionally applied to the handle member, or it can provide a clean finish to the handle member. Instead of a ring, it is also feasible according to the invention for any other decorative attachment piece, in particular a partial ring or an insert to accommodate the light source. The attachment piece is preferably an injection molded part, which may consist, for example, of polycarbonate (PC), acrylnitrile butadiene styrene (ABS), transparent PC, polymethylmetacrylate (PMMA), or some other suitable thermoplastic polymer. It is also feasible to produce the attachment piece from aluminum by means of injection molding, mechanical processing or some other machining process. The attachment piece can be lacquered or coated in some other manner, for example, by vapor deposition of a decorative, opaque or semitransparent surface design, by applying a film during the molding process, or using other coating techniques, such as hydrographic processes, ink-jet printing, etc. Furthermore, the attachment piece may also have a hard resistant surface coating. The surface can be worked as desired, for example, textured or non-textured, varnished, chromed, polished, etc. The foregoing applies to all the embodiments of the invention.

The attachment piece is preferably detachably connected to the handle; it may be engaged in the handle member, for example, by means of locking catches or clips. It may be held in place on the handle member by means of barbs and alternatively, or in addition thereto, it may be press-fitted on the handle member. If the attachment piece is in the form of a ring, it is slid, for example, at one end of the handle member onto the latter and is automatically positioned thereon by virtue of its shape. It is, of course, further possible to bond the attachment piece to the handle member, with a detachable connection being preferable. Mounting the attachment piece to and removing it from the handle member is uncomplicated and preferably accomplished without the use of tools, with the result that the attachment piece with integrated light source is easy to mount and replace. The attachment piece can also function as a fastening element for the handle member.

FIGS. 6a to 6c are exploded views and composite views of a preferred embodiment of the handle member according to the invention. Corresponding parts as in the foregoing exemplary embodiments are designated with like reference numerals. The above described applies to these as well. In the exemplary embodiments shown in FIGS. 6a to 6c, the handle member is attached to the interior trim 12 of a vehicle door, wherein the invention applies in like manner to other handle members at other locations in the vehicle. The handle member 10 in the exemplary embodiment shown comprises a two-part body 48 to which a lamination made, for example, of leather may be applied (not shown in FIG. 6). The body 48 is tapered at both ends, with which said body is incorporated into the interior trim 12, and two rings 18, 20 are slid onto the ends of the body to provide a visual accent between the handle member 10 and the interior door trim 12. In accordance with the invention, a lighting module 50 with a light source 22 is arranged at one or both ends of the handle member 10, wherein the light source 22 is integrated in the ring 18. In the exemplary embodiment shown, the lighting module 50 comprises the light source 22, a plug connector 54 and a flexible printed circuit board 52 which supports the light source and links it to the plug connector. The flexible printed circuit board 52 carries control and current supply leads for the light source 22 and, if necessary, additional circuit components for controlling the light source.

In the preferred embodiment the light source 22 is in the form of one or more LEDs, which can be soldered as SMD (Surface Mounted Device) components directly onto the flexible printed circuit board 52 or onto a rigid printed circuit board. The LEDs can, but do not have to, include a light conducting housing. The flexible printed circuit board 52 may include a FR4 substrate, a FPC (Ferrit Polymer Composite) film or some other suitable flexible support for the conducting paths for connecting the light source 22 with the plug connector 54 as well as, if necessary, for accommodating additional circuit components.

In alternative designs, the light source, in particular LED, can be incorporated on a rigid or flexible printed circuit board, which is connected via individual round connection cables or a flat ribbon cable to an electrical plug connector. It is also feasible to house the light source in a holder with integrated printed circuit board and to connect it via cables to the plug connector. It is further feasible to imbed the light source directly into the attachment piece, in the exemplary body shown, the ring, and if necessary to wire it.

In the exemplary embodiments shown in FIGS. 6a to 6c, the light source 22 of the lighting module 50 is accommodated in the ring 18 in such a way that light can be emitted through a recess 56 in the ring 18. The flexible printed circuit board 52 is passed along the outer side of the body 48 and in the exemplary embodiment shown, comes to rest closely against the tapered section 58 of the body 48. Together with this tapered section 58, the flexible printed circuit board 52 and the plug connector 54 are fed through a recess 60 in the interior trim 12 to the back side of the interior trim where they can be connected.

The handle member 10 according to the invention is mounted as follows: The rings 18, 20 are slid onto the ends of the handle member, whereby the light source 22 can already be integrated in the ring 18. Next, the handle member 10 is attached to the interior trim 12, with the flexible printed circuit board 52 and the plug connector 54 of the lighting module 50 being guided together with the tapered section 58 through the recess 60 in the interior trim. Subsequently, the opposite end of the handle member 10 is inserted into a corresponding recess 62 of the interior trim. To mount and connect the lighting module 50, no adaptation of the body 48 of the handle member 10 is required because the entire lighting module 50 is situated outside the body. Furthermore, mounting and positioning the light source 22 on the body 48 is extremely simple because the former together with the ring 18 are simply slid onto the body 48 and may be automatically positioned due to the shape of the ring 18.

In the embodiment shown, the ring together with the light source is initially slid onto the handle member before the handle member is attached to the interior trim. However, it is also feasible to initially attach the ring and light source to the interior trim, then mount the body 48 of the handle member. When mounting, the lighting module 50 can be attached to the handle member 10 or to the interior trim 12. Furthermore, the lighting module can be arranged between the handle member and the ring, or between the ring and the interior trim. Finally, it is also feasible to arrange the lighting module within the handle member and to guide the light source 22 through a passage in the body 48 of the handle member to the ring.

The foregoing also applies in like manner to any other decorative attachment piece and is not limited to a closed ring. A partial ring or insert of any desired shape may, for example, also be used as an attachment piece. In particular, the shape is dependent upon the design of the handle member as well as the opposing surfaces of the interior trim.

The part of the lighting module carrying the light source 22, or the light source per se, can be attached to the attachment piece, for example, by means of a coated adhesive film, for example, a PSA (pressure sensitive activity) adhesive tape. In alternative embodiments the part of the lighting module carrying the light source may also be press-fitted into the attachment piece and additionally or alternatively connected by adhering, welding, hot-gluing or by other suitable bonding techniques to the attachment piece. It is feasible to connect the part of the lighting module carrying the light source and the attachment piece in form-locking manner, and it is feasible to mold the part of the lighting module carrying the light source onto the attachment piece or to imbed it in the latter. The same applies to the light source per se. It is understood that this applies to all of the embodiments described.

In accordance with the invention, the light source may be combined with optics, the latter being provided either in the lighting module or on the handle member. In the simplest embodiment the attachment piece includes a simple opening through which light from the light source, for example, a LED, absent any additional optics passes through. In other embodiments an optical lens may be integrated in the attachment piece or provided in the lighting module. Other light-shaping optical components can also be used, such as coated or textured films having a scatter or diffraction pattern, including those with nano structures.

FIGS. 7a and 7b and FIG. 8 show two additional configurations for arranging the lighting module on the handle member in accordance with the invention. In the exemplary embodiments shown, the lighting module 50 in each Figure comprises a light source 22 in the form of, for example, a LED that is accommodated in a LED housing 64, which in the embodiment shown is connected by a flat ribbon cable 66 to the plug connector 54. In another configuration it is also feasible, for example, to outfit the lighting module or ring, or the light unit with a plug and connecting cable. The embodiments of FIGS. 7a, 7b and 8 differ from the foregoing embodiment in that the lighting module 50 is guided through the interior of the body 48 of the handle member. This requires provision of an opening 68 in the body 48 through which the LED housing 64 or its connecting leads are passed. In this exemplary embodiment the flat ribbon cable 66, a round cable or any other suitable connection between the light source and the plug connector is passed through the body 48 and exits at one or both ends of the handle member, as illustrated in FIGS. 7a and 7b.

FIG. 9 shows an example of how the light source 22 of the lighting module 50 can be arranged relative to the ring 18, the light source in this exemplary embodiment being imbedded in the ring.

FIGS. 10a to 10j show further examples of attachment pieces for accommodating the light source in the handle member according to the invention. In the example in FIG. 10a the attachment piece comprises a transparent ring covered by a semitransparent decorative layer, with the result that the entire ring is illuminated by the light source, indicated here by broken lines. FIG. 10b, 10c and 10d show attachment pieces in the form of opaque rings with openings for light emitted by the light source, which openings are arranged laterally or centrally in the ring, wherein lateral openings can point toward the handle member or toward the interior trim. The present invention is in no way limited to a particular direction of emission.

FIG. 10e shows another exemplary embodiment of an attachment piece in the form of an insert which has a partial ring shape. FIGS. 10f and 10g show two further exemplary embodiments of the attachment piece having different areas from which light is emitted. In FIG. 10f light is only emitted over a limited segment of the ring, while in FIG. 10g the ring forms a circumferential light source.

FIG. 10h shows an exemplary embodiment in which the light emitting surface extends about the entire periphery of the ring, but which includes a step or protrusion, and thus may be at least partially concealed in the mounted state.

In the exemplary embodiment of FIG. 10i the outlet for the light source is arranged laterally on the ring. In FIG. 10j the ring includes a circumferential surface for emitting light to the perimeter as well as to the side of the ring.

The present invention provides a solution for illuminating the area around a handle member on the interior trim of a motor vehicle, which is extremely simple and cost effective to produce and to install. The invention can also be used to illuminate the handle member itself or just the attachment piece as an aid to orientation and as a decorative element. By arranging the light source in the attachment piece and by providing the lighting module, positioning, sizing and attaching the light source are combined and implemented in an uncomplicated manner. The lighting module and the attachment piece can be mounted in advance and attached in a simple manner to the handle member. It is feasible to arrange the lighting module outside or inside the body of the handle member, whereby attaching the lighting module and the attachment piece does not require specialized tools. The solution is also suitable for coated and laminated handle members and, in a preferred embodiment thereof, requires no modification of the body of the handle member. The present invention also easily allows for the provision of different fittings for illuminating the handle members.

### LIST OF REFERENCE NUMERALS

10 handle member
12 interior trim
14 insert
16 armrest
18,20 rings, attachment piece
22 light source
24 illuminated area
26, 28 ring, attachment piece
30 interior trim of a liftgate
32 loading bed
34,36 ring, attachment piece
38 center console
40, 42 rings, attachment piece
44 roof liner
46 ring, attachment piece
48 body
50 lighting module
52 flexible printed circuit board
54 plug connector
56 recess
58 tapered section
60,62 recesses
64 LED housing
66 flat ribbon cable
68 passage

What is claimed is:

1. Handle member for a motor vehicle having a body and at least one decorative attachment piece, characterized in that a light source is integrated in the attachment piece.

2. Handle member according to claim 1, characterized in that the attachment piece is a ring that surrounds the body, a partial ring or an insert in the body.

3. Handle member according to claim 1, characterized in that the attachment piece is form- and/or force-fitted and is self-positioning in the body.

4. Handle member according to claim 1, characterized in that the attachment piece is detachably affixed to the body, in particular by a click-on or snap-on connection, by means of screws or pins.

5. Handle member according to claim 1, characterized in that the light source comprises at least one LED.

6. Handle member according to claim 1, having a lighting module which comprises the light source, a printed circuit board carried by the light source and a circuit for the light source on the printed circuit board.

7. Handle member according to claim 6, characterized in that the printed circuit board comprises a flexible printed circuit board which carries the current supply and/or control leads for the light source, or a rigid printed circuit board.

8. Handle member according to claim 1, characterized in that the light source is securely connected to the attachment piece.

9. Handle member according to claim 8, characterized in that the light source is adhered, welded or molded to the attachment piece.

10. Handle member according to claim 8, characterized in that the current supply and/or control leads of the light source are guided to the light source along the outside or inside of the body.

11. Handle member according to claim 1, characterized in that the attachment piece has an opening at which light emitted from the light source exits.

12. Handle member according to claim 11, characterized in that arranged within the opening over the light source is a light-shaping covering, in particular a lens arrangement or diffusor optics.

13. Handle member according to claim 12, characterized in that the covering comprises a light-diffusing film.

14. Handle member according to claim 1, characterized in that the handle member is designed to be mounted on an interior vehicle trim, in particular on or over a vehicle door, on a roof liner, on a vehicle console, on a liftgate or on a loading bed.

15. Handle member according to claim 14, characterized in that the light source is arranged in the handle member in such a way that it emits light for illuminating the interior vehicle trim, the handle member itself or for purposes of background illumination.
